(19) United States
(12) Patent Application Publication
(10) Pub. No.: US 2018/0072912 A1
(43) Pub. Date: Mar. 15, 2018

(54) WATERBORNE COPOLYMER DISPERSIONS WITH IMPROVED WET SCRUB RESISTANCE

(71) Applicant: Celanese International Corporation, Irving, TX (US)

(72) Inventors: Matthias JUNK, Alsbach-Hahnlein (DE); Thomas FICHTNER, Dalheim (DE); Stephan KRIEGER, Hofheim (DE); Ralf STURMER, Hattershheim (DE)

(21) Appl. No.: 15/261,342

(22) Filed: Sep. 9, 2016

(51) Int. Cl. C09D 133/12; C09D 7/12; C09D 5/03

(52) U.S. Cl. CPC C09D 133/12; C08K 3/34; C09D 5/03; C09D 7/1216

(57) ABSTRACT

An aqueous copolymer dispersion comprises at least one copolymer formed from a mixture comprising one or more main monomers selected from the group consisting of one or more vinyl esters of C₁-C₁₈ alkanoic acids, vinyl esters of aromatic acids, olefins, dienes, esters of ethylenically unsaturated carboxylic acids, vinylaromatics, and vinylhalogenides; from 0.05 to 5% by weight of one or more ethylenically unsaturated polycarboxylic acids or anhydrides thereof; from 0.05 to 10% by weight of one or more ethylenically unsaturated epoxy-containing compounds; and from 0.05 to 5% by weight of one or more hydrolyzable silicon compounds; wherein all percents are % by weight based on the total weight of the main monomers in the mixture.

### FIELD

The present development relates to waterborne copolymer dispersions with improved wet scrub resistance when used in coating compositions, particularly interior paints, including interior silicate paints.

### BACKGROUND

Waterborne copolymer dispersions are well known as binders in the production of coating compositions such as plasters, renders, adhesives, and paints. Advantages of using waterborne systems for paints include low cost, ease of application and cleanup, reduced drying times, and low or no odor or emissions of volatile organic compounds (VOC). For interior paints, where good mechanical properties at low binder content are required, wet scrub resistance (WSR) is a critical performance criterion. To date, many different proposals have been advanced to improve the wet scrub resistance of paints.

For example, U.S. Pat. No. 6,794,436 discloses a solvent-free pigmented formulation which, even at a high pigment volume concentration (PVC) of more than 75%, is said to exhibit very good resistance to wet abrasion and wet scrubbing. The formulation comprises I) a binder based on at least one copolymer P in an aqueous polymer dispersion obtainable by free-radical aqueous emulsion polymerization of a monomer mixture containing a) from 45 to 69.95% by weight of at least one monomer a) whose homopolymer has a glass transition temperature T_{g} of less than 20° C., such as C₁-C₁₀ alkyl acrylates and C₅-C₁₀ alkyl methacrylates b) from 30 to 54.95% by weight of at least one monomer b) whose homopolymer has a glass transition temperature T_{g} of more than 50° C., such as vinylaromatic monomers and α,β-unsaturated carbonitriles and carbodinitriles, c) from 0.05 to 1.5% by weight of itaconic acid and/or its anhydride and/or its salts, as acidic monomer c), and d) from 0 to 2% by weight of at least one further monomer d), the sum of the % by weight of a) to d) being 100% by weight, II) at least one pigment, III) at least one pigment dispersant having an acid number to DIN 53402 of less than 600, IV) if desired, an inorganic filler, and V) customary auxiliaries.

U.S. Pat. No. 6,624,243 discloses functionalized copolymers for preparing coating compositions useful for paints, which are said to have very good wet abrasion resistance in a variety of paint formulations, for example in both silicate-rich and carbonate-rich formulations. The formulations comprise a) one or more monomers from the group consisting of vinyl esters of unbranched or branched alkylcarboxylic acids having 1 to 15 carbon atoms, methacrylic esters and acrylic esters of alcohols having 1 to 15 carbon atoms, vinyl aromatics, olefins, dienes, and vinyl halides, b) from 0.05 to 5.0% by weight of one or more hydrolyzable silane monomers selected from the group consisting of ethylenically unsaturated, hydrolyzable silicon compounds, epoxysilanes, aminosilanes, and mercaptosilanes, c) from 0.05 to 5.0% by weight of one or more monomers from the group consisting of ethylenically unsaturated epoxide compounds, d) from 0 to 2.0% by weight of one or more monomers from the group consisting of ethylenically unsaturated 1,3-dicarbonyl compounds, the figures in % by weight being based in each case on the overall weight of the monomers a) used.

U.S. Pat. No. 9,034,944 discloses that aqueous copolymer dispersions comprising hydrolyzable silane compounds without any additional reactive groups may also have a very good wet scrub resistance in a variety of paint formulations. In particular, the aqueous copolymer dispersions comprise at least one copolymer formed from a mixture comprising: (a) one or more main monomers selected from the group consisting of vinyl esters of C₁-C₁₈ alkanoic acids, vinyl esters of aromatic acids, α-olefins, dienes, esters of ethylenically unsaturated carboxylic acids, vinylaromatics, and vinylhalogenides; (b) from 0.05 to 5% by weight of one or more silicon containing compounds having the formula (R¹)ₙ—Si—(OR²)₄₋ₙ, wherein n is 0, 1, 2, or 3, and R¹ and R² are each independently a C₁-C₁₅ alkyl, and wherein the one or more silicon containing compounds are substantially free of any reactive groups selected from the group consisting of mercapto groups, epoxy groups, ethylenically unsaturated groups, glycidyl groups, and amino groups; (c) from 0 to 5% by weight of one or more oxirane or hydroxyl-containing functional monomers; and (d) from 0 to 10% by weight of one or more auxiliary monomers different from (a)-(c); wherein all percents are % by weight based on the total weight of the main monomers in the monomer mixture.

U.S. Pat. No. 9,090,793 discloses a blend of an ethylene-vinyl acetate emulsion copolymer and a specific acrylic emulsion copolymer wherein the blend can be formulated into water-based paint compositions exhibiting desirable dry and wet adhesion characteristics and desirable resistance to blocking. The blend comprises (a) an ethylene-vinyl acetate emulsion copolymer formed from about 5 wt % to about 20 wt % of ethylene, from about 70 wt % to about 95 wt % of vinyl acetate, and from about 0 wt % to about 10 wt % of one or more auxiliary co-monomers; the ethylene-vinyl acetate emulsion copolymer being present in the blend in an amount from about 50 wt % to about 95 wt %; and (b) an acrylic emulsion copolymer formed from about 70 wt % to about 99 wt % of one or more C₁-C₁₂ esters of (meth)acrylic acid or one or more C₁-C₁₂ esters of (meth)acrylic acid in combination with one or more vinyl aromatic co-monomers, from about 0.1 wt % to about 10 wt % of one or more carboxy-functional co-monomers selected from (meth)acrylic acids, crotonic acid, itaconic acid, and combinations of these carboxy-functional co-monomers, from about 0.1 wt % to about 10 wt % of one or more carbonyl functional co-monomers, and from about 0 wt % to about 10 wt % of one or more auxiliary co-monomers; the acrylic emulsion copolymer being present in the blend in an amount from about 5 wt % to about 50 wt %, and (c) the blend further comprises a water-soluble cross-linking agent comprising at least two hydrazine moieties, said water-soluble cross-linking agent being present in said blend in an amount such that the molar ratio of hydrazine groups to carbonyl groups of the acrylic emulsion copolymer in said blend is between about 0.1 and 2.0.

International Patent Publication No. WO2015/193192 discloses an aqueous polymer dispersion obtained by radical aqueous emulsion polymerization of a monomer mixture containing (a) 30 to 70 parts by weight of at least one monomer whose homopolymer has a glass transition temperature T_{g}<25° C., (b) 30 to 70 parts by weight of at least one monomer whose homopolymer has a glass transition temperature T_{g}>25, (c) c) 0.1 to 5 parts by weight of at least one compound containing stabilizing groups d) 0.05 to 5 parts by weight of at least one copolymerizable monomer containing one or more hydrolysable silane monomers and (d) optionally further monomers. The dispersion is said to be useful as a binder for coating compositions with improved wet abrasion resistance, in particular for highly filled interior paints with a pigment volume concentration (PVC)>60, especially aqueous glass-containing or silicate-rich coating compositions.

Despite these advances, the state of the art only offers solutions for a specific PVC range of paints and is linked to a specific test method. There remains a need for versatile waterborne copolymer dispersions which exhibit excellent wet scrub performances over a broad PVC range, in various formulations, and with different test methods. Such dispersions would offer the advantage to be globally suitable in different regions where different test methods and paint formulations are used.

### SUMMARY

According to the invention, it has now surprisingly been found that the synergistic effect of three functional compounds increases the wet scrub resistance of polymer dispersions to unprecedented levels. Thus, when co-polymerized simultaneously with one or more main monomers, such as a (meth)acrylic acid ester, an ethylenically unsaturated polycarboxylic acid, an ethylenically unsaturated epoxide compound and a hydrolysable silane improve the wet scrub resistance of the resultant dispersion significantly beyond the values obtained for dispersions containing none, just one or any two of the three compounds. This improvement is seen with different pigment volume concentrations (matt, semi-gloss), with different formulations (standard interior or silicate paint), and according to different test methods (DIN EN ISO vs. ASTM).

Thus, in one aspect, the invention resides in an aqueous copolymer dispersion comprising at least one copolymer formed from a mixture comprising:

(a) one or more main monomers selected from the group consisting of one or more vinyl esters of C₁-C₁₈ alkanoic acids, vinyl esters of aromatic acids, olefins, dienes, esters of ethylenically unsaturated carboxylic acids, vinylaromatics, and vinylhalogenides;

(b) from 0.05 to 5%, preferably from 0.5 to 2%, by weight of one or more ethylenically unsaturated polycarboxylic acids or anhydrides thereof;

(c) from 0.05 to 10%, preferably from 0.2 to 3%, by weight of one or more ethylenically unsaturated epoxy-containing compounds; and

(d) from 0.05 to 5%, preferably from 0.1 to 3%, by weight of one or more hydrolyzable silicon compounds;

wherein all percents are % by weight based on the total weight of the main monomers in the mixture.

In a further aspect, the invention resides in an aqueous copolymer dispersion comprising at least one copolymer formed from a mixture comprising:

(a) one or more main monomers comprising one or more C₁-C₁₈ alkyl esters of acrylic acid and/or methacrylic acid;

(b) from 0.05 to 5%, preferably from 0.5 to 2%, by weight of itaconic acid or an anhydride thereof;

(c) from 0.05 to 0.2%, preferably from 0.2 to 3%, by weight of glycidyl methacrylate; and

(d) from 0.05 to 0.1%, preferably from 0.1 to 3%, by weight of one or more vinyl trialkoxysilane or γ-(meth)acryloxyalkyl trialkoxysilane monomers;

wherein all percents are % by weight based on the total weight of the main monomers in the monomer mixture.

In a further aspect, the invention resides in a coating composition, such as a paint comprising the aqueous copolymer dispersion described herein and at least one inorganic filler.

### DETAILED DESCRIPTION

Described herein is an aqueous copolymer dispersion which exhibits improved wet scrub resistance when used in a coating composition, such as a paint. The copolymer dispersion comprises at least one copolymer formed from a mixture comprising (a) one or more main monomers selected from the group consisting of one or more vinyl esters of C₁-C₁₈ alkanoic acids, vinyl esters of aromatic acids, olefins, dienes, esters of ethylenically unsaturated carboxylic acids, vinylaromatics, and vinylhalogenides; (b) from 0.05 to 5% by weight of one or more ethylenically unsaturated polycarboxylic acids or anhydrides thereof; (c) from 0.05 to 10% by weight of one or more ethylenically unsaturated epoxide compounds; and (d) from 0.05 to 5% by weight of one or more hydrolyzable silicon compounds; wherein all percents are based on the total weight of the main monomers in the monomer mixture.

### Main Monomers (a)

The aqueous copolymer dispersion comprises one or more main monomers (a) selected from the group consisting of vinyl esters of C₁-C₁₈ alkanoic acids, vinyl esters of aromatic acids, α-olefins, dienes, esters of ethylenically unsaturated carboxylic acids, vinylaromatics, and vinylhalogenides. In some embodiments, the aqueous copolymer dispersion may comprise from 80 to 99% by weight, e.g., from 90 to 95% by weight, of the one or more main monomers.

Exemplary vinyl esters of C₁-C₁₈ alkanoic acids include vinyl esters of carboxylic acids having 1 to 8 carbon atoms, such as, for example, vinyl formate, vinyl acetate, vinyl propionate, vinyl isobutyrate, vinyl pivalate and vinyl 2-ethylhexanoate. Suitable monomers also include vinyl esters of saturated, branched monocarboxylic acids having 9, 10 or 11 carbon atoms in the acid radical, e.g., versatic acid, and vinyl esters of relatively long-chain, saturated and unsaturated fatty acids, for example vinyl esters of fatty acids having 8 to 18 carbon atoms, such as, for example, vinyl laurate and vinyl stearate.

Exemplary vinyl esters of aromatic acids include esters of benzoic acid, 4-tert-butylbenzoic acid, or mixtures thereof.

Suitable α-olefins or diene monomers preferably have from 2 to 6 carbon atoms, and may include ethylene, propylene, isopropylene, n-butene, n-pentene, 1,3-butadiene, or mixtures thereof.

Suitable vinylhalogenides include vinyl fluoride, vinylidene fluoride, vinyl chloride, vinylidene chloride, and vinyl bromide.

Examples of suitable monomers of esters of ethylenically unsaturated carboxylic acids have 3 to 12 carbon atoms, such as esters of acrylic acid, methacrylic acid, crotonic acid, maleic acid, itaconic acid and fumaric acid. Preferred esters of α,β-unsaturated carboxylic acids include alkyl(meth)acrylates (i.e. alkyl esters of acrylic acid or of methacrylic acid). Examples of these are methyl acrylate, ethyl acrylate, propyl acrylate, butyl acrylate, 2-ethylhexyl acrylate, methyl methacrylate, ethyl methacrylate, propyl methacrylate, n-butyl methacrylate, tert-butyl methacrylate, isobutyl methacrylate, 2-ethylhexyl methacrylate, cyclohexyl methacrylate, cyclohexyl acrylate. Examples of esters of unsaturated dicarboxylic acids are dibutyl maleate and monooctylmaleate. These esters can be used alone or in the form of a combination of two or more esters.

In some embodiments, the main monomers (a) comprise (i) at least one monomer whose homopolymer has a glass transition temperature T_{g}<25° C., for example, ethyl acrylate, n-propyl acrylate, n-butyl acrylate, isobutyl acrylate, sec-butyl acrylate, n-hexyl acrylate, 2-ethylhexyl acrylate, n-hexyl methacrylate, 2-ethylhexyl, or 2-propylheptyl acrylate, or mixtures thereof and (ii) at least one monomer whose homopolymer has a glass transition temperature T_{g}>25° C., for example, styrene, α-methylstyrene, o- or p-vinyl toluene, vinyl chloride, vinylidene chloride, acrylonitrile, methacrylonitrile, and (C₁-C₄)-alkyl or cycloalkyl esters of methacrylic acid such as methyl methacrylate, cyclohexyl methacrylate, and tert-butyl methacrylate or mixtures thereof.

In one preferred embodiment, the main monomers (a) comprise one or more esters of ethylenically unsaturated carboxylic acids either alone or in combination with one of more vinylaromatics, especially styrene.

In some embodiments, the copolymer dispersion comprises more than 50 pphm, preferably more than 80 pphm, of monomer units based on C₁-C₁₈ alkyl esters of acrylic acid and/or methacrylic acid, where pphm means parts by weight per hundred parts by weight of the total monomers.

### Unsaturated Polycarboxylic Acids or Anhydrides (b)

In addition to the main monomers (a), the aqueous copolymer dispersion described herein comprises from 0.05 to 5%, preferably from 0.5 to 2%, by weight of one or more ethylenically unsaturated polycarboxylic acids or anhydrides thereof (b). Particularly suitable are ethylenically unsaturated dicarboxylic acids and anhydrides thereof. Examples include itaconic acid, maleic acid, citraconic acid, mesaconic acid, fumaric acid, itaconic anhydride, maleic anhydride, citraconic anhydride, mesaconic anhydride, and fumaric anhydride. Preferred monomers (b) are itaconic acid and itaconic anhydride.

### Epoxy-Containing Monomers (c)

A further component of monomer mixture employed to produce the present aqueous copolymer dispersion is from 0.05 to 10%, preferably from 0.2 to 3%, by weight of one or more ethylenically unsaturated epoxy-containing compounds (c). Examples of suitable monomers (c) include allyl glycidyl ether, methacryloyl glycidyl ether, butadiene monoepoxides, N-(2,3-epoxypropyl)acrylamide, N-(2,3-epoxypropyl)methacrylamide, 4-acrylamidophenylglycidyl ether, 3-acrylamidophenylglycidyl ether, 4-methacrylamidophenylglycidyl ether, 3-methacrylamidophenylglycidyl ether, N-glycidyloxymethylacrylamide, N-glycidyloxypropylmethacrylamide, N-glycidyloxyethylacrylamide, N-glycidyloxyethylmethacrylamide, N-glycidyloxypropylacrylamide, N-glycidyloxypropylmethacrylamide, N-glycidyloxybutylacrylamide, N-glycidyloxybutylmethacrylamide, 4-acrylamidomethyl-2,5-dimethylphenyl glycidyl ether, 4-methacrylamidomethyl-2,5-dimethylphenyl glycidyl ether, 3,4-expoxycyclohexylmethyl methacrylate, acrylamidopropyldimethyl(2,3-epoxypropyl)ammonium chloride, methacrylamidopropyldimethyl(2,3-epoxypropyl)ammonium chloride, glycidyl acrylate and glycidyl methacrylate. The preferred compound (c) is glycidyl methacrylate.

### Hydrolyzable Silicon Compounds (d)

Another essential compound employed to produce the present aqueous copolymer dispersion is from 0.05 to 5%, preferably from 0.1 to 3%, by weight of one or more hydrolyzable silicon compounds.

In some embodiments, the monomer mixture includes one or more ethylenically unsaturated silane compounds. Exemplary ethylenically unsaturated silane co-monomers have the structural formula I:

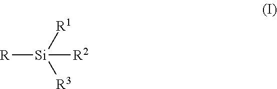

in which R denotes an organic radical olefinically unsaturated in the ω-position and R¹ R² and R³ which may be identical or different, denote halogen, chlorine, or the group —OZ, Z denoting hydrogen or primary or secondary alkyl or acyl radicals optionally substituted by alkoxy groups.

Suitable unsaturated silane compounds of the Formula I include those in which the radical R in the formula represents an ω-unsaturated alkenyl of 2 to 10 carbon atoms, particularly of 2 to 4 carbon atoms, or an ω-unsaturated carboxylic acid ester formed from unsaturated carboxylic acids of up to 4 carbon atoms and alcohols carrying the Si group of up to 6 carbon atoms. Suitable radicals R¹, R², R³ may be the group —OZ, Z representing primary and/or secondary alkyl radicals of up to 10 carbon atoms, for example, up to 4 carbon atoms, or alkyl radicals substituted by alkoxy groups, for example, of up to 3 carbon atoms, or acyl radicals of up to 6 carbon atoms, for example, of up to 3 carbon atoms, or hydrogen. Exemplary unsaturated silane co-monomers include vinyl trialkoxysilanes, where the alkoxy groups used may be methoxy, ethoxy, methoxyethylene, ethoxyethylene, methoxypropylene glycol ether or ethoxypropylene glycol ether radicals.

Exemplary unsaturated silane compounds of the Formula I include vinyltrichlorosilane, vinylmethyldichlorosilane, vinyltris 2-methoxyethoxy)silane, γ-methacryloxypropyltris(2-methoxyethoxy)silane, vinylmethoxysilanediol, vinyltrimethoxysilane, vinyltriethoxysilane, vinyldiethoxysilanol, vinylethoxysilanediol, allyltriethoxysilane, vinyltripropoxysilane, vinyltriisopropoxysilane, vinyltris-(1-methoxy)isopropoxysilane, vinyltributoxysilane, vinyltriacetoxysilane, trimethylglycolvinylsilane, γ-methacrylamidopropyltrimethoxysilane, γ-methacryloxypropylmethyldimethoxysilane, methacryloxymethyltrimethoxysilane, γ-methacryloxypropyltrimethylglycolsilane, γ-acryloxypropyltriethoxysilane and γ-methacryloxypropyltrimethoxysilane.

In other embodiments, one or more of the hydrolyzable silicon compounds is substantially free of any ethylenically unsaturated groups. Examples of such compounds have the formula (R¹)ₙ—Si—(OR²)₄₋ₙ (II), wherein n is 0, 1, 2, or 3, and R¹ and R² are each independently a C₁-C₁₅ alkyl and more preferably from C₁-C₆ alkyl. The alkyl groups may be straight or branched but contain no unsaturation. Suitable compounds of formula (II) are selected from the group consisting of tetramethoxysilane, tetraethoxysilane, alkyltrimethoxysilane, alkyltriethoxysilane, dialkyldimethoxysilane, dialkyldiethoxysilane, trialkylmethoxysilane, and trialkylethoxysilane. Suitable silicon containing compounds include tetramethoxysilane, tetraethoxysilane, methyltrimethoxysilane, ethyltrimethoxysilane, propyltrimethoxysilane, butyltrimethoxysilane, pentyltrimethoxysilane, hexyltrimethoxysilane, methyltriethoxysilane, ethyltriethoxysilane, propyltriethoxysilane, butyltriethoxysilane, pentyltriethoxysilane, and hexyltriethoxysilane. Other suitable silanes carry at least one amino, epoxy, ureido, or mercapto functional group on R¹. Examples of this class of saturated silanes include N-(2-aminoethyl)-3-aminopropyltrimethoxysilane, N-(2-aminoethyl)-3-aminopropylmethyldimethoxysilane, N-cyclohexyl-3-aminopropyltrimethoxysilane, N-phenyl-3-aminopropyltrimethoxysilane 3-aminopropyltrimethoxysilane, 3-aminopropyl triethoxysilane, γ-ureidopropyltrimethoxysilane β-(3,4-epoxycyclohexyl)ethyltrimethoxysilane and γ-glycidoxypropyl trimethoxysilane, γ-glycidoxypropyltriethoxysilane, γ-mercaptopropyltrimethoxysilane, γ-mercaptopropyltriethoxysilane, γ-mercaptopropylmethyldiethoxysilane. Since they do not form part of the final copolymer, such saturated hydrolyzable silicon compounds can be added before, during or after the polymerization process.

Preferred hydrolyzable silicon compounds are ethylenically unsaturated silanes. Particularly preferred are vinyl trialkoxysilanes and/or γ-(meth)acryloxyalkyl trialkoxysilanes, such as vinyl trimethoxysilane, vinyl triethoxysilane and γ-methacryloxypropyl trimethoxysilane and mixtures thereof.

### Optional Comonomers

In addition to the main monomers (a) and the co-monomers (b), (c) and (d), the monomer mixture employed to produce the present aqueous copolymer dispersion may contain from 0 to 10% by weight, e.g., from 0.3 to 10% by weight or from 0.5 to 5% by weight, of one or more optional co-monomers.

In addition to ethylenically unsaturated dicarboxylic acids and anhydrides, the dispersion may contain one or more acid monomers comprising at least one of an ethylenically unsaturated monocarboxylic acid or an anhydride or amide thereof, an ethylenically unsaturated sulfonic acid, or an ethylenically unsaturated phosphonic or phosphoric acid.

For example, the acid monomer may comprise an ethylenically unsaturated C₃-C₈ monocarboxylic acid or the anhydride or amide thereof. Examples of suitable ethylenically unsaturated C₃-C₈ monocarboxylic acids include acrylic acid, methacrylic acid and crotonic acid.

Examples of suitable ethylenically unsaturated sulfonic acids include those having 2-8 carbon atoms, such as vinylsulfonic acid, 2-acrylamido-2-methylpropanesulfonic acid, 2-acryloyloxyethanesulfonic acid and 2-methacryloyloxyethanesulfonic acid, 2-acryloyloxy- and 3-methacryloyloxypropanesulfonic acid. Examples of suitable ethylenically unsaturated phosphonic or phosphoric acids include vinylphosphonic acid, esters of phosphonic or phosphoric acid with hydroxyalkyl(meth)acrylates and ethylenically unsaturated polyethoxyalkyletherphosphates.

In addition to or instead of said acids, it is also possible to use the salts thereof, preferably the alkali metal or ammonium salts thereof, particularly preferably the sodium salts thereof, such as, for example, the sodium salts of vinylsulfonic acid and of 2-acrylamidopropanesulfonic acid.

Additionally or alternatively, the monomer composition employed to produce the polymer dispersion employed herein may optionally include one or more functional co-monomers adapted to promote better film or coating performance by the final coating composition. Such desirable film/coating properties can include, for example, enhanced adhesion to surfaces or substrates, improved wet adhesion, and improved resistance to film or coating cracking. The optional co-monomers useful for incorporation into the emulsion copolymers of the compositions include ureido co-monomers, carbonyl-functional monomers, cross-linking comonomers and combinations of these auxiliary optional co-monomers.

Cyclic ureido co-monomers are known to impart improved wet adhesion properties to films and coatings formed from copolymers containing these co-monomers. Cyclic ureido compounds and their use as wet adhesion promoting co-monomers are disclosed in U.S. Pat. Nos. 4,104,220; 4,111,877; 4,219,454; 4,319,032; 4,599,417 and 5,208,285. The disclosures of all of these U.S. patents are incorporated herein by reference in their entirety.

Other suitable functional co-monomers include unsaturated compounds that contain one or more carbonyl moieties. Examples of such suitable co-monomers include diacetone acrylamide (DAAM), polymerizable 1,3-dicarbonyl compounds and polymerizable 1,3-diketoamides. Suitable polymerizable 1,3-dicarbonyl compounds include acetoacetoxyethyl acrylate, acetoacetoxyethyl methacrylate (AAEM), acetoacetoxypropyl methacrylate, acetoacetoxybutyl methacrylate, 2,3-di(acetoacetoxy)propyl methacrylate and allyl acetoacetate. Such monomers are known to impart improved wet adhesion properties to coating compositions, especially on alkyd substrates (See DE 2535372 A1). Suitable polymerizable 1,3-diketoamides include those compounds described in U.S. Pat. No. 5,889,098, which patent is incorporated herein by reference. Examples of compounds of this type include amido acetoacetonates such as 3-isopropenyl-α,α-dimethylbenzyl amidoacetoacetate, 4-isopropenyl-α,α-dimethylbenzyl amidoacetoacetate, 4-ethylenyl-phenyl amidoacetoacetate and the like.

Optionally, the monomer compositions used in the present dispersion may also contain monomers with at least two non-conjugated ethylenically unsaturated groups. Such cross-linking co-monomers include triallyl cyanurate, triallyl isocyanurate, diallyl maleate, diallyl fumarate, divinyl benzene, diallyl phthalate, hexanediol diacrylate, ethyleneglycol dimethacrylate, and polyethylene glycol diacrylate.

In some embodiments, the overall copolymer has a T_{g} value from −10 to 50° C., preferably from 0 to 30° C., as measured by differential scanning calorimetry (DSC) according to ISO 16805.

### Stabilization System

Both during polymerization and thereafter, the present copolymer is stabilized in the form of an aqueous copolymer dispersion or latex. The copolymer dispersion therefore will be prepared in the presence of and will contain a stabilization system which generally comprises emulsifiers, in particular nonionic emulsifiers and/or anionic emulsifiers and/or protective colloids. Mixtures of the different stabilizers can also be employed.

The amount of emulsifier employed will generally be at least 0.5 wt. %, based on the total quantity of main monomers in the copolymer dispersion. Generally emulsifiers can be used in amounts up to about 8 wt. %, based on the total quantity of main monomers in the copolymer dispersion. Emulsifiers employed with preference herein are nonionic emulsifiers having alkylene oxide groups and/or anionic emulsifiers having sulfate, sulfonate, phosphate and/or phosphonate groups. Such emulsifiers, if desired, can be used together with molecularly or dispersely water-soluble polymers. Preferably, the emulsifiers used contain no alkylphenolethoxylate (APEO) structural units.

Examples of suitable nonionic emulsifiers include acyl, alkyl, oleyl, and alkylaryl ethoxylates. These products are commercially available, for example, under the name Genapol®, Lutensol® or Emulan®. They include, for example, ethoxylated mono-, di-, and tri-alkylphenols (EO degree: 3 to 50, alkyl substituent radical: C₄ to C₁₂) and also ethoxylated fatty alcohols (EO degree: 3 to 80; alkyl radical: C₈ to C₃₆), especially C₁₀-C₁₄ fatty alcohol (3-40) ethoxylates, C₁₁-C₁₅ oxo-process alcohol (3-40) ethoxylates, C₁₆-C₁₈ fatty alcohol (11-80) ethoxylates, Cᵢᵢ oxo-process alcohol (3-40) ethoxylates, C₁₃ oxo-process alcohol (3-40) ethoxylates, polyoxyethylenesorbitan monooleate with 20 ethylene oxide groups, copolymers of ethylene oxide and propylene oxide having a minimum ethylene oxide content of 10% by weight, the polyethylene oxide (4-40) ethers of oleyl alcohol, and the polyethene oxide (4-40) ethers of nonylphenol. Particularly suitable are the polyethylene oxide (4-40) ethers of fatty alcohols, more particularly of oleyl alcohol, stearyl alcohol or C₁₁ alkyl alcohols.

The amount of nonionic emulsifiers used in preparing the copolymer dispersions herein is typically up to about 8% by weight, preferably up to about 5% by weight, more preferably up to about 4% by weight, based on the total main monomer quantity. Mixtures of nonionic emulsifiers can also be employed.

Examples of suitable anionic emulsifiers include sodium, potassium, and ammonium salts of linear aliphatic carboxylic acids of chain length C₁₂-C₂₀, sodium hydroxyoctadecanesulfonate, sodium, potassium, and ammonium salts of hydroxy fatty acids of chain length C₁₂-C₂₀ and their sulfonation and/or sulfation and/or acetylation products, alkyl sulfates, including those in the form of triethanolamine salts, alkyl(C₁₀-C₂₀) sulfonates, alkyl(C₁₀-C₂₀) arylsulfonates, and their sulfonation products, lignosulfonic acid and its calcium, magnesium, sodium, and ammonium salts, resin acids, hydrogenated and dehydrogenated resin acids, and their alkali metal salts, dodecylated sodium diphenyl ether disulfonate, sodium lauryl sulfate, sulfated alkyl or aryl ethoxylate with EO degree between 1 and 30, for example ethoxylated sodium lauryl ether sulfate or a salt of a bisester, preferably of a bis-C₄-C₁₈ alkyl ester, of a sulfonated dicarboxylic acid having 4 to 8 carbon atoms, or a mixture of these salts, preferably sulfonated salts of esters of succinic acid, more preferably salts, such as alkali metal salts, of bis-C₄-C₁₈ alkyl esters of sulfonated succinic acid, or phosphates of polyethoxylated alkanols.

The amount of anionic emulsifiers used can typically range from about 0.1% to about 3.0% by weight, preferably from about 0.1% to about 2.0% by weight, more preferably from about 0.5% to about 1.5% by weight, based on the total main monomer quantity. Mixtures of anionic emulsifiers can also be employed.

Also suitable as stabilizers for the present dispersions are copolymerizable nonionic and anionic surfactants such as those disclosed in US 2014/0243552. Other suitable copolymerizable surfactants are sold under the trade names Hitenol® BC, Hitenol® KH, Hitenol® AR, Adeka Reasoap SR, and Adeka Reasoap ER.

Along with emulsifiers, the aqueous copolymer dispersions employed in accordance with the present development may also comprise as part of the stabilizer system a selected type of protective colloid based on cellulose ethers, poly vinyl alcohol, poly vinyl pyrolidone, polyacrylic acid, maleic acid styrene copolymers or other water soluble polymers. Suitable protective colloids used in the copolymer dispersions herein include water-soluble or water-dispersible polymeric modified natural substances based on cellulose ethers. Such cellulose ethers have a viscosity, when tested as a 1 wt. % aqueous in water at 25° C., of 5 to 5,000 mPas, preferably of 10 to about 1,500 mPas, more preferably 10 to 500 mPas. Mixtures of celluloses ethers may be used to achieve these viscosity values. Examples of suitable cellulose ether materials include methyl cellulose, hydroxyethyl cellulose, hydroxypropyl cellulose, hydroxypropyl methyl cellulose, ethyl hydroxyethyl cellulose, methyl hydroxyethyl cellulose and combinations of these cellulose ethers. Carboxymethyl cellulose (CMC) is most preferred, as described in U.S. Pat. No. 4,492,780.

Hydrophobically modified cellulose ethers may also be employed as the protective colloid in the copolymer dispersions herein. Such materials comprise cellulose ethers which have been hydrophobically modified with long chain hydrocarbon groups to reduce their water solubility. Hydrophobically modified cellulose ethers of this type are those described, for example, in U.S. Pat. Nos. 4,228,277; 4,352,916 and 4,684,704; all of which patents are incorporated herein by reference.

The protective colloids can be used individually or in combination. In the case of combinations, the two or more colloids can each differ in their molecular weights or they can differ in their molecular weights and in their chemical composition, such as the degree of hydrolysis, for example.

When protective colloids are used, the amount thereof, based on the total amount of monomers used, is typically from 0.1 to 5 parts by weight, preferably from 0.3 to 5 parts by weight.

In a preferred variant, the present dispersions contain no protective colloid at all, or the amount of protective colloid, based on the total amount of monomers used, is less than 1% by weight, more preferably less than 0.7% by weight.

In a particularly preferred variant, the present dispersions neither contain protective colloids nor nonionic emulsifiers.

In addition to the emulsifiers and protective colloids that are used during the emulsion polymerization of the copolymers herein, it is also possible to add further emulsifiers, protective colloids and/or other stabilizers after the polymerization.

### Copolymer Dispersion Preparation

The copolymer dispersions described herein can be prepared using emulsion polymerization procedures which result in the preparation of polymer dispersions in aqueous latex form. Such preparation of aqueous polymer dispersions of this type is well known and has already been described in numerous instances and is therefore known to the skilled artisan. Such procedures are described, for example, in U.S. Pat. No. 5,849,389, and in the Encyclopedia of Polymer Science and Engineering, Vol. 8, p. 659 (1987), the disclosures of both of these publications are incorporated herein by reference in their entirety.

The polymerization may be carried out in any manner known per se in one, two or more stages with different monomer combinations, giving polymer dispersions having particles with homogeneous or heterogeneous, e.g., core shell, hemispheres or gradient morphology. Any reactor system such as batch, loop, continuous, cascade, etc. may be employed.

The polymerization temperature generally ranges from 20° C. to 150° C., more preferably from 50° C. to 120° C. The polymerization may take place under pressure in case a gaseous monomer is used.

The copolymerisation can be undertaken by batch, semi batch or continuous emulsions polymerization, i.e. by processes in which all the monomer is added upfront or by monomer slow add processes.

In a typical polymerization procedure involving, for example, aqueous copolymer dispersions, main monomers (a), and the co-monomers (b), (c) and (d), can be polymerized in an aqueous medium under pressures up to 120 bar in the presence of one or more initiators, at least one emulsifying agent and optionally a protective colloid component. In one embodiment, the aqueous reaction mixture in the polymerization vessel can be maintained at a pH of about 2 to about 7 by a suitable buffering agent.

The manner of combining the several polymerization ingredients, i.e. emulsifiers, monomers, initiators, protective colloids, etc., can vary widely. Generally an aqueous medium containing at least some of the emulsifier(s) can be initially formed in the polymerization vessel with the various other polymerization ingredients being added to the vessel thereafter.

Monomers can be added to the polymerization vessel continuously, incrementally or as a single charge addition of the entire amounts of co-monomers to be used. Co-monomers can be employed as pure monomers or can be used in the form of a pre-mixed emulsion. Where present, ethylene as a co-monomer can be pumped into the polymerization vessel and maintained under appropriate pressure therein.

It is also possible to start the emulsion polymerization using a seed latex, for example with about 0.5 to about 15% by weight of the dispersion.

As noted, the polymerization of the ethylenically unsaturated monomers will generally take place in the presence of at least one initiator for the free-radical polymerization of these co-monomers. Suitable initiators for the free-radical polymerization, for initiating and continuing the polymerization during the preparation of the dispersions, include all known initiators which are capable of initiating a free-radical, aqueous polymerization in heterophase systems. These initiators may be peroxides, such as alkali metal and/or ammonium peroxodisulfates, organic hydroperoxides, more particularly water-soluble ones, or azo compounds, more particularly water-soluble azo compounds.

As polymerization initiators, it is also possible to use what are called redox initiators. Examples thereof are peroxodisulfates, tert-butyl hydroperoxide and/or hydrogen peroxide in combination with reducing agents, such as with sulfur compounds, an example being the sodium salt of hydroxymethanesulfinic acid, Bruggolite® FF6 and FF7 sodium sulfite, sodium disulfite, sodium thiosulfate, and acetone-bisulfite adduct, or with ascorbic acid, sodium erythobate, tartaric acid, or with reducing sugars.

The amount of the initiators or initiator combinations used in the process varies within what is usual for aqueous polymerizations in heterophase systems. In general the amount of initiator used will not exceed 5% by weight, based on the total amount of the co-monomers to be polymerized. The amount of initiators used, based on the total amount of the co-monomers to be polymerized, is preferably 0.05% to 2.0% by weight.

In this context, it is possible for the total amount of initiator to be included in the initial charge to the reactor at the beginning of the polymerization. More preferably, a portion of the initiator is included in the initial charge, and the remainder is added after the polymerization has been initiated, in one or more steps or continuously. The addition may be made separately or together with other components, such as emulsifiers or monomer emulsions. The molecular weight of the various copolymers in the copolymer dispersions herein can be adjusted by adding small amounts of one or more molecular weight regulator substances. These regulators are generally used in an amount of up to 2% by weight, based on the total co-monomers to be polymerized. As regulators, it is possible to use all of the substances known to the skilled artisan. Preference is given to organic thio compounds such as methylthiol, ethyithiol, n-propylthid, n-butylthiol, n-hexylthiol, n-octylthiol, n-decylthiol, n-dodecylthiol, n-tetradecylthiol, n-hexadecylthiol, n-octadecylthiol, cyclohexylthiol, isopropylthiol, tert-butylthiol, tert-nonylthiol, tert-dodecylthiol, 4-methylbenzene thiol, 2-mercaptopropionic acid, isooctyl 3-mercaptopropionate, 4,4′-thiobisbenzenethiol, pentaerythritol tetrakis(2-mercaptoacetate) and pentaerythritol tetrakis(3-mercaptopropionate).

Following polymerization, the solids content of the resulting aqueous copolymer dispersions can be adjusted to the level desired by the addition of water or by the removal of water by distillation. Generally, the desired level of polymeric solids content after polymerization is from about 40 weight percent to about 70 weight percent based on the total weight of the polymer dispersion, more preferably from about 45 weight percent to about 55 weight percent.

On completion of the polymerization, a further, preferably chemical after-treatment, especially with redox catalysts, for example combinations of the above-mentioned oxidizing agents and reducing agents, may follow to reduce the level of residual unreacted monomer on the product. In addition, residual monomer can be removed in known manner, for example by physical demonomerization, i.e. distillative removal, especially by means of steam distillation, or by stripping with an inert gas. A particularly efficient combination uses both physical and chemical methods, which permits lowering of the residual monomers to very low contents (<1000 ppm, preferably <100 ppm).

The polymerized particles produced by the present process typically have a weight-averaged diameter of less than 200 nm, preferably less than 150 nm, as measured by a combination of laser diffraction and polarization intensity differential scattering (PIDS) using a Beckman Coulter LS 13320 Particle Size Analyzer.

In addition to monomers described herein, the final polymers may also contain a water-soluble cross-linking agent. Such a cross-linking agent will react with specific polymer functionalities such as carbonyl or 1,3-dicarbonyl groups as water is removed from the coating compositions herein and as a film or coating is formed from the polymerized components.

A type of water-soluble cross-linking agent that can be used in the compositions herein comprises a compound which contains at least two hydrazine and/or hydrazide moieties. Particularly suitable are dihydrazine compounds of aliphatic dicarboxylic acids of 2 to 10, in particular 4 to 6, carbon atoms, e.g., oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide and/or itaconic acid dihydrazide. Water-soluble aliphatic dihydrazines of 2 to 4 carbon atoms, e.g., ethylene-1,2-dihydrazine, propylene-1,3-dihydrazine or butylene-1,4-dihydrazine, are also suitable. Adipic acid dihydrazide (ADH) is a preferred water-soluble cross-linking agent for use in the compositions herein, especially those produced from monomer compositions containing diacetone acrylamide (DAAM).

Other suitable water-soluble cross-linking agents are compounds which contain at least two amine functional moieties such as ethylene diamine and hexamethylene diamine Such cross-linking agents are preferred in combination with polymers comprising 1,3-dicarbonyl groups, such as acetoacetoxyethyl methacrylate (AAEM).

Generally, such water-soluble cross-linking agents are post added to the dispersion such that the molar ratio of cross-linking agent functional groups to polymer functional groups is between about 0.1 and about 2.0. More preferably the molar ratio of cross-linking agent functional groups to copolymer functional groups in the blend will be between about 0.5 and 2.0.

After polymerization the dispersion is typically neutralized to alkaline pH. This can be accomplished by, for example, the addition of an organic or inorganic base, such as an amine, ammonia or an alkali metal hydroxide, such as potassium hydroxide. In some embodiments, it is preferred to effect neutralization with a nitrogen-free base.

In addition, before use, the copolymer dispersion can be dried to form a water redispersible powder, for example, to assist storage or transportation.

### Coating Compositions

The aqueous copolymer dispersion described herein is particularly useful as binder for waterborne coating compositions with low emission regarding Total Volatile Organic Compound (TVOC) and Total Semi Volatile Organic Compound (TsVOC) content which fulfil the requirements of the EU Ecolabel as defined in the Commission Decision 2014/312/EU. A volatile organic compound is defined herein as a carbon containing compound that has a boiling point below 250° C. at atmospheric pressure (as defined in the Commission Decision 2014/312/EU). The TVOC content may be determined by gas chromatography according to ISO 11890-2, or alternatively for products with a VOC content of less than 1.0 g/L according to ISO 17895. sVOC compounds have a boiling point above 250° C. (as defined in detail in the Commission Decision 2014/312/EU) and may be determined by gas chromatography according to ISO 11890-2.

Coating compositions prepared with the aqueous copolymer dispersions described herein will generally fulfill the criteria of the EU Ecolabel, e.g., TVOC<10 g/L in interior matt paints based on the total weight of the coating. In one embodiment, they contain less than <1 g/L TVOC. Where appropriate, the coating compositions used herein can also optionally comprise a wide variety of conventional additives, such as fillers, pigments, and auxiliaries including defoamers, surfactants, dispersants, biocides, rheology modifiers, freeze-thaw additives, formaldehyde scavenger like urea, complexing agents like EDTA or thickeners, which are typically used in the formulation of binders and/or adhesives. Such optional additives may be present in the copolymer dispersion from the beginning of or during polymerization, may be added to the dispersion post-polymerization or, such as in the case of fillers, may be used in connection with preparation of the aqueous coating compositions from the copolymer dispersions as hereinafter described.

In one embodiment, conventional optional additives for the copolymer dispersions herein can include, for example, film-forming assistants, such as white spirit, Texanol®, TxiB®, butyl glycol, butyl diglycol, butyl dipropylene glycol, and butyl tripropylene glycol; wetting agents, such as AMP 90®, TegoWet 280®, Fluowet PE®; defoamers, such as mineral oil defoamers or silicone defoamers; UV protectants, such as Tinuvin® 1130; agents for adjusting the pH; preservatives; plasticizers, such as dimethyl phthalate, diisobutyl phthalate, diisobutyl adipate, Coasol B®, Plastilit 3060®, and Triazetin®; subsequently added stabilizing polymers, such as polyvinyl alcohol or additional cellulose ethers; and other additives and auxiliaries of the kind typical for the formulation of binders. The amounts of these additives used in the aqueous copolymer dispersions herein can vary within wide ranges and can be selected by the specialist in view to the desired area of application. The preferred embodiment does not contain any film coalescing agents.

The aqueous copolymer dispersions according to the invention are used, for example, as binders in pigment-containing, aqueous preparations which serve for the coating of substrates. Preferred coating compositions include emulsion paints, emulsion finishes and glazes. Paint formulations may include low emission interior or exterior paints. In the context of using the aqueous copolymer dispersions in coating compositions, a particular feature of the aqueous copolymer dispersions is the ability to confer a very good wet scrub resistance over a broad range of pigment volume concentrations (PVC),

In one embodiment, the coating composition may comprise from 30 to 90% of at least one filler, from 0.1 to 25% of at least one pigment, and from 5 to 60%, preferably from 5 to 50% of the aqueous copolymer dispersion of the present invention. The coating composition may also comprise one or more components selected from the group consisting of defoamers, surfactants, dispersants, biocides, rheology modifiers, freeze-thaw additives, and thickeners.

The copolymer dispersions as hereinbefore described may be combined with filler material, additional water and/or any optional other ingredients, such as one or more auxiliaries, to form the aqueous coating compositions herein. The solids content of the aqueous compositions so formed will generally range from about 30 wt % to about 75 wt % of the total composition. More preferably, the solids content of the aqueous coating compositions herein will range from about 40 wt % to about 65 wt % of the total composition. These are to be understood as meaning all constituents of the preparation except for water, but at least the total amount of solid binder, filler, pigment, plasticizer and polymeric auxiliaries.

The pigment volume concentration (PVC) of the pigment-containing, aqueous preparations according to the invention is in general above 5%, preferably in the range from 10 to 90%. In particularly preferred embodiments, the PVCs are either in the range from 10 to 45% or in the range from 60 to 90%.

Pigments which may be used are all pigments known to the person skilled in the art for said intended use. Preferred pigments for the aqueous preparations according to the invention, preferably for emulsion paints, are, for example, titanium dioxide, preferably in the form of rutile, barium sulfate, zinc oxide, zinc sulfide, basic lead carbonate, antimony trioxide and lithopone (zinc sulfide and barium sulfate). The aqueous preparations may also contain colored pigments, for example iron oxides, carbon black, graphite, luminescent pigments, zinc yellow, zinc green, ultramarine, manganese black, antimony black, manganese violet, Paris blue or Schweinfurt green. In addition to the inorganic pigments, the preparations according to the invention may also contain organic colored pigments, for example sepia, gamboge, Cassel brown, toluidine red, para red, Hansa yellow, indigo, azo dyes, anthraquinoid and indigoid dyes and dioxazine, and quinacridone, phthalocyanine, isoindolinone and metal complex pigments.

Fillers which may be used are all fillers known to the person skilled in the art for said intended use. Preferred fillers are aluminosilicates, such as, for example, feldspars, silicates, such as, for example, kaolin, talc, mica, magnesite, alkaline earth metal carbonates, such as, for example, calcium carbonate, for example in the form of calcite or chalk, magnesium carbonate, dolomite, alkaline earth metal sulfates, such as, for example, calcium sulfate, and silica. The fillers can be used either as individual components or as filler mixtures. Filler mixtures, such as, for example, calcium carbonate/kaolin and calcium carbonate/talc, are preferred in practice.

In order to increase the hiding power and to save white pigments, finely divided fillers, such as, for example, precipitated calcium carbonate or mixtures of different calcium carbonates having different particle sizes, are preferably frequently used in emulsion paints. Mixtures of colored pigments and fillers are preferably used for adjusting the hiding power of the hue and the depth of color.

The customary auxiliaries include wetting agents or dispersants, such as sodium, potassium, or ammonium polyphosphates, alkali metal and ammonium salts of polyacrylic acids and of polymaleic acid, polyphosphonates, such as sodium 1-hydroxyethane-1,1-diphosphonate, and naphthalenesulfonic acid salts, in particular sodium salts thereof. In addition, suitable amino alcohols, such as, for example, 2-amino-2-methylpropanol, may be used as dispersants. The dispersants or wetting agents are preferably used in an amount of from 0.1 to 2% by weight, based on the total weight of the emulsion paint.

Furthermore, the auxiliaries may also comprise thickeners, for example cellulose derivatives, such as methylcellulose, hydroxyethylcellulose and carboxymethylcellulose, and furthermore casein, gum Arabic, tragacanth gum, starch, sodium alginate, polyvinyl alcohol, polyvinylpyrrolidone, sodium polyacrylates, water-soluble copolymers based on acrylic and (meth)acrylic acid, such as acrylic acid/acrylamide and (meth)acrylic acid/acrylic ester copolymers and so-called associative thickeners, such as styrene/maleic anhydride polymers or preferably hydrophobically modified polyetherurethanes (HEUR) known to the person skilled in the art, hydrophobically modified acrylic acid copolymers (HASE) polyetherpolyols. Inorganic thickeners, such as, for example, bentonites or hectorite, may also be used. The thickeners are preferably used in amounts of from 0.1 to 3% by weight, particularly preferably from 0.1 to 1% by weight, based on the total weight of the aqueous preparation.

In addition, waxes based on paraffins and polyethylene, and dulling agents, antifoams, preservatives and water repellents, biocides, fibers and further additives known to the person skilled in the art may also be used as auxiliaries in the aqueous preparations according to the invention.

The dispersions according to the invention can be used to produce not only solvent- and plasticizer-free preparations but also coating systems which contain solvents and/or plasticizers as film formation auxiliaries. Film formation auxiliaries are generally known to the person skilled in the art and can be used generally in amounts of from 0.1 to 20% by weight, based on the vinyl ester copolymer present in the preparation, so that the aqueous preparation has a minimum film formation temperature of less than 15° C., preferably in the range from 0° C. to 10° C. In a preferred embodiment, the aqueous preparations according to the invention contain no film formation auxiliary. In this case, the coating composition may have a minimum film forming temperature of less than or equal to 5° C. without addition of film forming agents.

The aqueous preparations according to the invention are stable fluid systems which can be used for coating a multiplicity of substrates. Consequently, the present invention also relates to methods for coating substrates and to the coating materials themselves. Suitable substrates are, for example, wood, concrete, mineral substrates, metal, glass, ceramics, plastic, renders, wallpapers, paper and coated, primed or weathered substrates. The application of the preparation to the substrate to be coated is effected in a manner dependent on the form of the preparation. Depending on the viscosity and the pigment content of the preparation and on the substrate, the application can be effected by means of roll-coating, brushing, knife-coating or as a spray.

When used as paints, the coating compositions of the invention exhibit excellent wet scrub resistance and typically have at least a wet scrub class II according to EN 13300. For example, a matt interior paint produced with the present copolymer dispersion and having a polymer content on dry paint of less than 15%, preferably less than 11%, may exhibit at least a wet scrub class II according to EN 13300. In addition, a matt silicate paint produced with the present copolymer dispersion and having a polymer content on dry paint of less than 15%, preferably less than 11%, may also exhibit at least a wet scrub class II according to EN 13300. In addition, a satin or semi-gloss interior paint produced with the present copolymer dispersion and having a polymer content on dry paint of less than 45%, preferably less than 42%, may exhibit a wet scrub resistance of at least 500 cycles according to ASTM D 2486.

The invention will now be more particularly described with reference to the following non-limiting Examples.

### Examples 1-3 (Comparative)

A 3 liter reactor equipped with a reflux condenser and an anchor stirrer was filled with 660 g of deionized (DI) water and 21.4 g of a 28% aqueous solution of a sodium C₁₁ alkyl ether sulfate with 7 ethylene oxide units. The reactor content was heated to 80° C. and 2.4% of the monomer feed, as described in Table 1, was added. A solution of 0.6 g sodium persulfate in 12 g of water was added and the reactor contents were held at 80° C. for 15 min. Subsequently, the remaining amount of monomer feed was added to the reactor with constant dosage rate over 180 min. The reactor temperature during the feed addition was maintained at 80° C. After completion of the feed addition, the reactor content was held at 85° C. for 60 minutes and then cooled to room temperature. 180 g of caustic soda (5%) were then added to the dispersion.

The properties of the resulting polymer dispersions are summarized in Table 2.

### Example 4 (Inventive)

The process of Examples 1-3 was repeated with varying monomer feed composition, as described in Table 1.

The properties of the resulting polymer dispersion are summarized in Table 2.

TABLE 1
Composition of the monomer feeds (in grams)

| | Ex. 1 | Ex. 2 | Ex. 3 | Ex. 4 |
|---|---|---|---|---|
| DI water | 535 | 535 | 535 | 535 |
| Sodium C₁₁ alkyl ether sulfate, | 43 | 43 | 43 | 43 |
| 28% in water | | | | |
| Sodium persulfate | 5 | 5 | 5 | 5 |
| Methacrylic acid (MAA) | 24 | 0 | 24 | 0 |
| Acrylic acid (AA) | 12 | 0 | 12 | 0 |
| Itaconic acid (IA) | 0 | 18 | 0 | 18 |
| Methyl methacrylate (MMA) | 564 | 564 | 564 | 564 |
| 2-Ethylhexyl acrylate (EHA) | 636 | 636 | 636 | 636 |
| Vinyl triethoxysilane | 0 | 0 | 9 | 9 |
| Glycidyl methacrylate | 0 | 0 | 12 | 12 |

TABLE 2
Properties of the polymer dispersions

| | Solid | Brookfield | | | |
|---|---|---|---|---|---|
| | content (%)¹ | viscosity (mPa s)² | pH | d_{w} (nm)³ | T_{g} (° C.)⁴ |
| Example 1 | 45.5 | 73 | 8.4 | 120 | 6.7 |
| Example 2 | 45.6 | 36 | 8.5 | 120 | 1.2 |
| Example 3 | 45.8 | 110 | 8.4 | 120 | 9.9 |
| Example 4 | 45.9 | 36 | 8.4 | 120 | 4.5 |

¹gravimetric determination after 24 h drying at 110° C.
²measurement conditions: 20° C., 20 rpm, spindle 1
³weight-average particle diameter as determined by a Beekman Coulter LS 13320 Particle Size Analyzer
⁴Glass transition temperature as measured by differential scanning calorimetry (DSC) according to ISO 16805

### Examples 5-8 (Inventive and Comparative Matt Interior Paints)

Coalescent-free matt interior paints were prepared by mixing the ingredients in Table 3 at room temperature under stirring. After dissolving and dispersing item nos. 2-4 in the water, pigment and fillers as per item nos. 5-9 were dispersed consecutively by increasing the dissolver speed to 5000 rpm. After the preparation of the mill base, item nos. 10-11 were added while gently stirring. The resulting paints had a solid content of approx. 64% and a pigment volume concentration (PVC) of approx. 79%.

TABLE 3
Composition of matt interior paints

| | | | | Parts per |
|---|---|---|---|---|
| Item | | Supplier | Description | weight |
| 1 | Water | | | 281 |
| 2 | Tylose ® MH 6000 | SE Tylose | Cellulosic | 4.5 |
| | YG8 | | thickener | |
| 3 | Lopon ® LF | ICL | Dispersing agent | 4 |
| 4 | Agitan ® 381 | Münzing | Defoamer | 2 |
| 5 | Kronos ® 2044 | Kronos | Titanium dioxide | 125 |
| 6 | Omyacarb ® 2 GU | Omya | Calcium carbonate | 150 |
| 7 | Omyacarb ® 5 GU | Omya | Calcium carbonate | 125 |
| 8 | Dorkafill ® H | Dorfner | Calcined kaolin | 150 |
| 9 | Sipernat ® 820 A | Evonik | Sodium aluminum | 15 |
| | | | silicate | |
| 10 | Agitan ® 381 | Münzing | Defoamer | 2 |
| 11 | Dispersion per | | | 141.5 |
| | Ex. 1-4 | | | |

### Examples 9-12 (Inventive and Comparative Silicate Interior Paints)

Coalescent-free silicate paints were prepared by mixing the ingredients in Table 4 at room temperature under stirring. After dissolving and dispersing item nos. 2-5 in the water, pigment and fillers as per item nos. 6-9 were dispersed consecutively by increasing the dissolver speed to 5000 rpm. After the preparation of the mill base, item nos. 10-12 were added while gently stirring. The resulting paints had a solid content of approx. 57% and a pigment volume concentration (PVC) of approx. 76%.

TABLE 4
Composition of silicate interior paints

| | | | | Parts per |
|---|---|---|---|---|
| Item | | Supplier | Description | weight |
| 1 | Water | | | 320 |
| 2 | Lopon ® 890 | ICL | Dispersing agent | 2 |
| 3 | Tylose ® H 30000 | SE Tylose | Cellulosic | 4 |
| | YP2 | | thickener | |
| 4 | Lopon ® 827 | ICL | Stabilizer | 3 |
| 5 | Agitan ® 281 | Münzing | Defoamer | 3 |
| 6 | Kronos ® 2300 | Kronos | Titanium dioxide | 120 |
| 7 | Omyacoat ® | Omya | Calcium carbonate | 135 |
| | 850-OG | | | |
| 8 | Omya ® BL | Omya | Calcium carbonate | 180 |
| 9 | MicaCelia 125 L | Ziegler | Muscovite mica | 50 |
| 10 | Dispersion per | | | 133 |
| | Ex. 1-4 | | | |
| 11 | Tego ® Phobe | Evonik | Hydrophobizing | 5 |
| | 1401 | | agent | |
| 12 | Betolin ® K 28 | Wöllner | Potassium | 45 |
| | | | silicate binder | |

### Examples 13-16 (Inventive and Comparative Satin Interior Paints)

Coalescent-free satin interior paints were prepared by mixing the ingredients in Table 5 at room temperature under stirring. After dissolving and dispersing item nos. 2-5 in the water, pigment and fillers as per item nos. 6-7 were dispersed consecutively by increasing the dissolver speed to 5000 rpm. After the preparation of the mill base, item nos. 8-10 were added while gently stirring. The resulting paints had a solid content of approx. 61% and a pigment volume concentration (PVC) of approx. 31%.

TABLE 5
Composition of satin interior paints

| | | | | Parts per |
|---|---|---|---|---|
| Item. | | Supplier | Description | weight |
| 1 | Water | | | 67 |
| 2 | Tylose ® H 15000 | SE Tylose | Cellulosic | 2 |
| | YP2 | | thickener | |
| 3 | Calgon ® N, 10% | ICL | Dispersing agent | 12 |
| 4 | Lopon ® LF | ICL | Dispersing agent | 3 |
| 5 | Agitan ® 315 | Münzing | Defoamer | 4 |
| 6 | Kronos ® 2160 | Kronos | Titanium dioxide | 220 |
| 7 | Hydrocarb ® OG | Omya | Calcium carbonate | 130 |
| 8 | Caustic soda, 10% | | | 2 |
| 9 | Dispersion per | | | 550 |
| | Ex. 1-4 | | | |
| 10 | Tafigel ® PUR 50 | Münzing | Rheology modifier | 10 |

### Examples 17-20 (Inventive and Comparative Semi-Gloss Interior Paints)

Semi-gloss interior paints were prepared by mixing the ingredients in Table 6 at room temperature under stirring. After dissolving and dispersing item nos. 2-7 in the water, pigment and fillers as per item nos. 8-10 were dispersed consecutively by increasing the dissolver speed to 5000 rpm. After the preparation of the mill base, item nos. 11-17 were added while gently stirring. The resulting paints had a solid content of approx. 47% and a pigment volume concentration (PVC) of approx. 24%.

TABLE 6
Composition of semi-gloss interior paints

| | | | | Parts per |
|---|---|---|---|---|
| Item. | | Supplier | Description | weight |
| 1 | Water | | | 256.9 |
| 2 | Natrosol ™ Plus 330 | Ashland | Cellulosic | 4.7 |
| | | | thickener | |
| 3 | AMP-95 ® | Dow | Base | 0.4 |
| 4 | Acticide ® BW-20 | Thor | Preservative | 1.9 |
| 5 | Foamaster ® MO 2185 | BASF | Defoamer | 2.8 |
| 6 | Tamol ™ 1124 | Dow | Pigment | 2.8 |
| | Dispersant | | dispersant | |
| 7 | Carbowet ® 106 | Air | Wetting agent | 3.7 |
| | | Products | | |
| 8 | Tronox ® CR-826 | Tronox | Titanium | 186.8 |
| | | | dioxide | |
| 9 | Burgess No. 28 | Burgess | Kaolin | 23.4 |
| 10 | Minex ® 10 | Unimin | Nepheline | 23.4 |
| | | | syenite | |
| 11 | Dispersion per Ex. 1-4 | | | 461.9 |
| 12 | Water | | | 15.9 |
| 13 | Foamaster ® MO 2185 | BASF | Defoamer | 0.9 |
| 14 | Celanese CLX | Celanese | Coalescent | 7 |
| 15 | Rheolate ® 678 | Elementis | Thickener | 2.7 |
| 16 | Rheolate CVS ®-10 | Elementis | Thickener | 2.9 |
| 17 | Foamaster ® MO 2185 | BASF | Defoamer | 1.9 |

The wet scrub resistance (WSR) of the above paints was tested by means of the nonwoven pad method according to ISO 11998 or with a Nylon brush according to ASTM D 2486.

According to ISO 11998, the paints were applied onto Leneta foil P121-10N with a 300 μm scraper. After drying for 28 days at 23° C. and 50% relative humidity, the paint films were inserted into abrasion tester model 494 (Erichsen) with adapters for wet scrub tests according to ISO 11998 and scrubbed with Scotch-Brite™ Handpad 7448, Type S Ultra Fine (3M) after treatment of pad and film with a 0.25% aqueous solution of sodium n-dodecylbenzenesulfonate. Reported is the thickness loss of the paint film in μm after 200 cycles and the corresponding classification according to EN 13300.

According to ASTM D 2486, the paints were applied onto Leneta foil P121-10N with a 7 mil scraper. After drying for 7 days at 23° C. and 50% relative humidity, the paint films were inserted into a Washability & Wear Tester, model D10V (Gardco), coated with 5 mL destilled water and scrubbed with a Nylon brush, which was pretreated with 10 g of Abrasive Leneta Scrub Media SC-2. After 400 cycles, the treatment with water and abrasive fluid was repeated. Reported is the number of scrub cycles which is needed to completely remove the paint film over a length of 0.5 inches.

The wet scrub resistances of the matt and silicate paints according to ISO 11998 are listed in Tables 7 and 8 and classified according to EN 13300. Class II paints according to EN 13300 are considered high quality paints. The wet scrub resistances of the satin, and semi-gloss paints according to ASTM D 2486 are listed in Tables 9 and 10. Paints with a wet scrub resistance of >500 cycles are considered high quality paints. The wet scrub performance of comparative and inventive dispersions in different interior paints are summarized in Table 11.

TABLE 7
Wet scrub resistance of matt interior paints

| | | | | WSR ISO 11998 | EN 13300 |
|---|---|---|---|---|---|
| Ex. | IA | GMA | Silane | (μm) | class |
| 5 (comp.) | — | — | — | 107 | IV |
| 6 (comp.) | x | — | — | 38 | III |
| 7 (comp.) | — | x | x | 64 | III |
| 8 (inv.) | x | x | x | 17 | II |

TABLE 8
Wet scrub resistance of silicate paints

| | | | | WSR ISO 11998 | EN 13300 |
|---|---|---|---|---|---|
| Ex. | IA | GMA | Silane | (μm) | class |
| 9 (comp.) | — | — | — | 44 | III |
| 10 (comp.) | x | — | — | 37 | III |
| 11 (comp.) | — | x | x | 14 | II |
| 12 (inv.) | x | x | x | 10 | II |

TABLE 9
Wet scrub resistance of satin paints

| | | | | WSR ASTM D 2486 |
|---|---|---|---|---|
| Ex. | IA | GMA | Silane | (cycles) |
| 13 (comp.) | — | — | — | 320 |
| 14 (comp.) | x | — | — | 1235 |
| 15 (comp.) | — | x | x | 200 |
| 16 (inv.) | x | x | x | 1095 |

TABLE 10
Wet scrub resistance of semi-gloss paints

| | | | | WSR ASTM D 2486 |
|---|---|---|---|---|
| Ex. | IA | GMA | Silane | (cycles) |
| 17 (comp.) | — | — | — | 258 |
| 18 (comp.) | x | — | — | 733 |
| 19 (comp.) | — | x | x | 72 |
| 20 (inv.) | x | x | x | 627 |

TABLE 11
Wet scrub summary

| | | | Wet scrub | Wet scrub |
|---|---|---|---|---|
| | Wet scrub class | Wet scrub class | resistance >500 | resistance >500 |
| | II (EN 13300) | II (EN 13300) | cycles (ASTM D | cycles (ASTM D |
| | of matt paint | of silicate paint | 2486) of satin | 2486) of semi-gloss |
| | according to | according to | paint according to | paint according to |
| Dispersion | table 7 | table 8 | table 9 | table 10 |
| Ex. 1 (comp.) | no | no | no | no |
| Ex. 2 (comp.) | no | no | yes | yes |
| Ex. 3 (comp.) | no | yes | no | no |
| Ex. 4 (inv.) | yes | yes | yes | yes |

It can be seen that only the inventive polymer dispersion containing a combination of itaconic acid, glycidyl methacrylate, and hydrolyzable silane compound provides excellent wet scrub performances over a wide range of pigment volume concentrations, paint formulations and test methods. The polymeric binder comprising itaconic acid without GMA and hydrolyzable silane (ex. 2) performs well in satin and semi-gloss paints but leads to deficient wet scrub performances in matt paints and, in particular, silicate paints. The polymeric binder containing GMA and hydrolyzable silane without itaconic acid (ex. 3) yields excellent wet scrub results when used in a silicate paint, but leads to deficient performances in a matt paint and particularly in satin and semi-gloss paints.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. An aqueous copolymer dispersion comprising at least one copolymer formed from a mixture comprising:
(a) one or more main monomers selected from the group consisting of one or more vinyl esters of C₁-C₁₈ alkanoic acids, vinyl esters of aromatic acids, olefins, dienes, esters of ethylenically unsaturated carboxylic acids, vinylaromatics, and vinylhalogenides;
(b) from 0.05 to 5%, preferably from 0.5 to 2%, by weight of one or more ethylenically unsaturated polycarboxylic acids or anhydrides thereof;
(c) from 0.05 to 10%, preferably from 0.2 to 3%, by weight of one or more ethylenically unsaturated epoxy-containing compounds; and
(d) from 0.05 to 5%, preferably from 0.1 to 3%, by weight of one or more hydrolyzable silicon compounds;
wherein all percents are % by weight based on the total weight of the main monomers in the mixture.

2. The dispersion of claim 1, where the dispersion is obtained by free radical emulsion polymerization.

3. The dispersion of claim 1, wherein the one or more main monomers (a) comprise one or more esters of ethylenically unsaturated carboxylic acids.

4. The dispersion of claim 3, wherein the one or more main monomers (a) comprise one or more vinylaromatics.

5. The dispersion of claim 1, wherein the copolymer comprises more than 50 pphm of monomer units based on C₁-C₁₈ alkyl esters of acrylic acid and/or methacrylic acid.

6. The dispersion of claim 1, wherein the one or more main monomers (a) are selected from the group consisting of methyl acrylate, ethyl acrylate, butyl acrylate, 2-ethyl hexyl acrylate, decyl acrylate, methyl methacrylate, butyl methacrylate, iso-butyl methacrylate, styrene, and combinations thereof.

7. The dispersion of claim 1, wherein the one or more ethylenically unsaturated polycarboxylic acids or anhydrides thereof (b) are selected from the group consisting of itaconic acid, maleic acid, citraconic acid, mesaconic acid, fumaric acid and anhydrides thereof.

8. The dispersion of claim 1, wherein the one or more ethylenically unsaturated polycarboxylic acids or anhydrides thereof (b) comprise itaconic acid or an anhydride thereof.

9. The dispersion of claim 1, wherein the one or more ethylenically unsaturated epoxy-containing compounds (c) are selected from the group consisting of allyl glycidyl ether, methacryloyl glycidyl ether, butadiene monoepoxides, N-(2,3-epoxypropyl)acrylamide, N-(2,3-epoxypropyl)methacrylamide, 4-acrylamidophenylglycidyl ether, 3-acrylamidophenyl glycidyl ether, 4-methacrylamidophenylglycidyl ether, 3-methacrylamidophenylglycidyl ether, N-glycidyloxymethylacrylamide, N-glycidyloxypropylmethacrylamide, N-glycidyloxyethylacrylamide, N-glycidyloxyethylmethacrylamide, N-glycidyloxypropylacrylamide, N-glycidyloxypropylmethacrylamide, N-glycidyloxybutylacrylamide, N-glycidyloxybutylmethacrylamide, 4-acrylamidomethyl-2,5-dimethylphenyl glycidyl ether, 4-methacrylamidomethyl-2,5-dimethylphenyl glycidyl ether, acrylamidopropyldimethyl(2,3-epoxypropyl) ammonium chloride, methacrylamidopropyldimethyl(2,3-epoxypropyl)ammonium chloride, glycidyl acrylate and glycidyl methacrylate.

10. The dispersion of claim 1, wherein the one or more ethylenically unsaturated epoxy-containing compounds comprise glycidyl methacrylate.

11. The dispersion of claim 1, wherein the one or more hydrolyzable silicon compounds are ethylenically unsaturated.

12. The dispersion of claim 11, wherein the one or more ethylenically unsaturated, hydrolyzable silicon compounds comprise vinyl trialkoxysilane monomers or γ-(meth)acryloxyalkyl trialkoxysilanes wherein the alkoxy group has from 1 to 4 carbon atoms.

13. The dispersion of claim 1 and having a T_{g} value from −10 to 50° C. as measured by differential scanning calorimetry (DSC) according to ISO 16805.

14. An aqueous copolymer dispersion comprising at least one copolymer formed from a mixture comprising:
(a) one or more main monomers comprising one or more C₁-C₁₈ alkyl esters of acrylic acid and/or methacrylic acid;
(b) from 0.05 to 5%, preferably from 0.5 to 2%, by weight of itaconic acid or an anhydride thereof;
(c) from 0.05 to 10%, preferably from 0.2 to 3%, by weight of glycidyl methacrylate; and
(d) from 0.05 to 5%, preferably from 0.1 to 3%, by weight of one or more vinyl trialkoxysilane and/or γ-(meth)acryloxyalkyl trialkoxysilane monomers;
wherein all percents are % by weight based on the total weight of the main monomers in the monomer mixture.

15. A water redispersible powder comprising a dried form of the dispersion of claim 1.

16. A paint comprising the dispersion of claim 1 and at least one inorganic filler.

17. The paint of claim 16 having at least a wet scrub class II according to EN 13300.

18. The paint of claim 16 which fulfills the requirements of the EU Ecolabel as defined in the Commission Decision 2014/312/EU regarding Total Volatile Organic Compound (TVOC) and Total Semi Volatile Organic Compound (TsVOC) content.

19. The paint of claim 16, wherein the at least one inorganic filler comprises a carbonate.

20. The paint of claim 16, wherein the at least one inorganic filler comprises a silicate.

21. A matt interior or silicate paint according to claim 16 with a polymer content on dry paint of less than 15% and having at least a wet scrub class II according to EN 13300.

22. A satin or semi-gloss interior paint according to claim 16 with a polymer content on dry paint of less than 45% and having at wet scrub resistance of at least 500 cycles according to ASTM D 2486.
